(19) United States
(12) Patent Application Publication
(10) Pub. No.: US 2025/0117241 A1
(43) Pub. Date: Apr. 10, 2025

(54) Backup and Restore of Containers Running in Virtual Machines

(71) Applicant: VMware LLC, Palo Alto, CA (US)

(72) Inventors: KIRAN KUMAR CHERIVIRALA, Bangalore (IN); GURIVI REDDY GOPIREDDY, Bangalore (IN); VENKATA VANAJA LAKSHMI YAKKALA, Bangalore (IN); SUJEET BANERJEE, Bangalore (IN); VIJAYRAMARAJU SAMANURI, Bangalore (IN); RAJDEEP PAIDI, Bangalore (IN)

(21) Appl. No.: 18/607,333

(22) Filed: Mar. 15, 2024

(30) Foreign Application Priority Data
Oct. 6, 2023 (IN) 202341067126

(51) Int. Cl. G06F 9/455; G06F 11/14

(52) U.S. Cl. CPC G06F 9/45558; G06F 11/1448; G06F 2201/815

(57) ABSTRACT

One or more embodiments provide a method for data storage. For example, the method may include adding a second virtual disk to the VM, the second virtual disk backed by a second virtual disk file. The method may also include creating one or more volumes configured to store container data of the one or more containers, the one or more volumes using storage from the second virtual disk and not the first virtual disk. The method may furthermore include mounting the one or more volumes in the one or more containers. The method may in addition include backing up the second virtual disk file independent from the first virtual disk file to create a copy of the second virtual disk file.

### CROSS-REFERENCES

This application claims the benefit of Indian Patent Application number 202341067126, entitled “BACKUP AND RESTORE OF CONTAINERS RUNNING IN VIRTUAL MACHINES,” filed on Oct. 6, 2023, of which is hereby incorporated by reference in its entirety.

### BACKGROUND

Virtualization is a process whereby software is used to create an abstraction layer over computer hardware that allows the hardware elements of a single computer to be divided into multiple virtual computers. The software used is called a hypervisor-a small layer that enables multiple operating systems (OSs) to run alongside each other, sharing the same physical computing resources. When a hypervisor is used on a physical server (also known as a bare metal server or a host) in a data center, the hypervisor allows the physical computer to separate its OS and applications from its hardware thereby enabling the creation and management of virtual machines (VMs). The result is that each VM contains a guest OS, virtualized hardware that the guest OS requires to run, and one or more application(s) and their associated libraries and dependencies. Other types of virtual computing instances (VCIs) may also be used similarly as VMs.

While virtualization enables running multiple OSs on the hardware of a single physical server, containerization, on the other hand, enables deploying multiple applications using the same OS on a single VM or server. In particular, containerization is the packaging of software code with just the OS libraries and dependencies required to run the code (e.g., in a container image) to create a single lightweight executable, referred to as a container, which runs consistently on any infrastructure. Containers simplify delivery of distributed applications, and have become increasingly popular as organizations shift to cloud-native development and hybrid multi-cloud environments.

In order to preserve data generated by a running container, and/or to share data between containers, traditional persistent storage, often referred to as persistent volume(s) or container volume(s), is created for the container. A container volume may use as storage a portion of a virtual disk (e.g., a subset of the blocks of the virtual disk) that, as is known in the art, is an abstraction of a physical storage disk that a container accesses using input/output (I/O) accesses as though it was a physical disk. In particular, a virtual disk file is created for and provides physical storage backing the virtual disk. The virtual disk file is stored on a mass storage device of a host system. The mass storage device (or, simply, storage) may be locally connected to the host system or may be connected via a network, such as a network attached storage arrangement or a cloud storage arrangement. In addition to providing storage for the container volume, the virtual disk backed by the virtual disk file also provides storage for a VM volume that contains VM data, such as runtime data, VM configuration data, guest OS, etc.

It is generally good practice to periodically backup data of the virtual machine, which can be accomplished by making a copy of the virtual disk file at preset intervals. Since the virtual disk file contains both VM data and container data, the copy of the virtual disk file provides a full back up of the entire VM environment. However, copying a virtual disk file that contains both VM data and container data can be a time consuming and resource intensive endeavor. In fact, the guest OS portion, alone, may occupy several Gigabytes of space of the virtual disk file. Moreover, the VM data, with the exception of guest OS updates, rarely changes in significant way, while the container data may be constantly changing and those changes may be of significant importance to the operator of the VM environment. Thus, the VM data would require infrequent backup, while the container data would require frequent backups.

Accordingly, there is a need in the art for techniques that facilitate efficient backup and restore of container volumes deployed in a VM environment.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for data storage. For example, the method may include adding a second virtual disk to the VM, the second virtual disk backed by a second virtual disk file. The method may also include creating one or more volumes configured to store container data of the one or more containers, the one or more volumes using storage from the second virtual disk and not the first virtual disk. The method may furthermore include mounting the one or more volumes in the one or more containers. The method may in addition include backing up the second virtual disk file independent from the first virtual disk file to create a copy of the second virtual disk file.

Further embodiments include one or more non-transitory computer-readable media comprising instructions that, when executed by one or more processors of a computer system, cause the computer system to carry out the above method(s). Further embodiments include a computer system comprising at least one memory and one or more processors configured to carry out the above method(s).

### BRIEF DESCRIPTION OF THE DRAWINGS

FIG. 1 depicts a computing system in which embodiments described herein may be implemented.

FIG. 2 depicts a block representation of an example data storage backup system, in accordance with the present application.

FIG. 3 depicts a method flow representation of an example embodiment for managing container data, in accordance with the present application.

FIG. 4 depicts a method flow representation of another example embodiment for restoring one or more containers, in accordance with the present application.

FIG. 5 depicts a method flow representation of another example embodiment for installing a VM with containers, in accordance with the present application.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In prior art systems with containers running on VMs, container data and VM data are backed by the same virtual disk file(s). For example, container volumes and VM volumes use the storage area of the same virtual disk backed by the same virtual disk file. Thus, backing up container data often requires backing up the entire virtual disk that includes both container data and VM data. This can be a lengthy process and require significant storage space, especially if backups are generated on a regular schedule. Similarly, restoring container data requires that both the container data and the VM data be restored.

Aspects of the present disclosure introduce a data storage structure that provides, in certain embodiments, increased efficiency for backup and restore processes. Aspects of the present disclosure separate storage space of the VM volume from storage space of the container volumes by having the VM volume use storage from a separate virtual disk backed by a separate virtual disk file from one or more virtual disks backed by one or more virtual disk files that provide storage for one or more container volumes. For example, VM data may be stored in a first virtual disk backed by a first virtual disk file, and container data may be stored in one or more container volumes using storage of one or more other virtual disks backed by one or more other virtual disk files. Though certain aspects are described with respect to the VM data being stored in a first virtual disk backed by a first virtual disk file, the VM data may similarly be backed by a plurality of first virtual disks backed by a plurality of first virtual disk files. Similarly the container data may be stored in one or more container volumes using storage of a second plurality of virtual disks backed by a second plurality of virtual disk files. In other words, VM data may reside on one or more first virtual disks of one or more first virtual disk files, and container data (e.g., container volumes, a cluster store, etc.) may reside on one or more second virtual disks of one or more second virtual disk files.

Backups can be performed on the container volume(s) independent of backups of the VM data by backing up the one or more other virtual disk files separately from the first virtual disk file(s). Since significant changes to the VM data occur infrequently, the VM data can be backed up at infrequent intervals. On the other hand, container data may change often, and so frequent backups may preserve the data in case of a system failure.

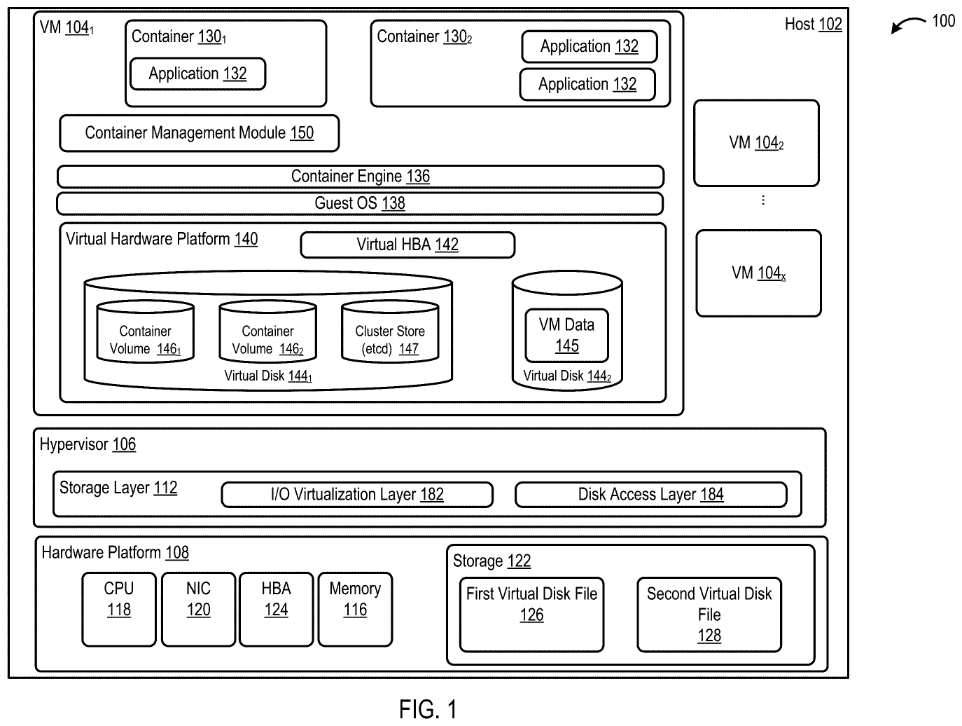

FIG. 1 is a block diagram that illustrates a computing system 100 in which embodiments described herein may be implemented. Computing system 100 includes a host 102 configured to provide a virtualization layer, also referred to as a hypervisor 106, that abstracts processor (e.g., CPU 118), memory 116, storage 122, and networking resources e.g., network interface card (NIC) 120) of hardware platform 108 into multiple VMs 1041 to 104X (collectively referred to as VMs 104 and individually referred to as VM 104) that run concurrently on the same host 102.

Each VM 104 implements a virtual hardware platform 140 that supports the installation of a guest OS 138 which is capable of executing one or more applications. Guest OS 138 may be a standard, commodity operating system. Examples of a guest OS include Microsoft Windows, Linux, Unix, and the like.

A virtual hardware platform 140 provides the VM 104 with virtualized hardware components backed by the components of the hardware platform 108. For example, a virtual host bus adapter (HBA) 142, backed by HBA 124 of the hardware platform 108, provides, to guest OS 138, the functionality of disk storage support to enable execution of guest OS 138 as though guest OS 138 is executing on physical system hardware. In certain embodiments, a virtual disk exposes the same abstraction as a real (physical) disk, that is, a linear list of addressable sectors. However, a hypervisor 106 may store images backing the storage virtual disks as regular disk files shown in FIG. 1 as first virtual disk file 126 and second virtual disk file 128 stored on storage 122. Thus, abstractions of a virtual disk 1442 backed by the virtual disk file 126, and a virtual disk 1441 backed by the virtual disk file 128, may be provided to the VM 104 in virtual hardware platform 140. Virtual disk 1442 may be accessed by the VM 104 as a standard mass storage device in which VM data 145 is stored. The VM data 145 may include runtime data, VM configuration data, guest OS, applications, etc. As noted, though not shown, there may be additional virtual disk files for additional virtual disks.

In certain embodiments, a VM 104 may further include a container engine 136 installed therein and running as a guest application under control of guest OS 138. Container engine 136 is a process that enables the deployment and management of virtual instances (referred to interchangeably herein as “containers 130”) by providing a layer of OS-level virtualization on guest OS 138 within VM 104. Containers 1301 and 1302 (collectively referred to as containers 130 and individually referred to as container 130) are software instances that enable virtualization at the OS level. That is, with containerization, the kernel of guest OS 138 is configured to provide multiple isolated user space instances, referred to as containers. Containers 130 appear as unique servers from the standpoint of an end user that communicates with each of containers 130. However, from the standpoint of the guest OS 138 on which the containers 130 execute, the containers 130 are user processes that are scheduled and dispatched by the OS. Examples of a container engine 136 include the open-source Docker platform made available by Mirantis, Inc. which previously acquired Docker, Inc, Kubernetes, etc. In FIG. 1, two containers 1301 and 1302 are shown, however, any number of containers 130 can be implemented by the VM 104, which may be limited by available system (host 102) resources (e.g., processing bandwidth, memory 116, storage 122, etc.).

Container engine 136 provides the containers 130 with storage resources, such as by configuring one or more container volumes that may be mounted in the containers. In certain aspects, the container volume(s) may use storage area of one or more virtual disks. For example, container volumes 1461 and 1462 (collectively referred to as container volume 146 and individually referred to as container volume 146) use storage resources of virtual disk 1441, also referenced herein as container virtual disk 1441, backed by second virtual disk file 128. As discussed, there may be additional virtual disks backed by additional virtual disk files that store container data (e.g., are used by container volumes for storage, by a cluster store, etc.).

Containers 130 encapsulate one or more applications, such as application 132 as a single executable package of software that bundles application code together with all of the related configuration files, libraries, and dependencies required for it to run. Application 132 may be any software program, such as a word processing program, HTTP server, content management system (CMS), machine learning (ML) and artificial intelligence (AI) models, network router/firewall. Binaries/libraries and other runtime components are developed or executed separately for each container 130.

In certain embodiments, each VM 104 further includes a container management module 150. Container management module 150, in general, manages the lifecycle of each container 130, including, but not limited to, creation, use, and deletion of containers 130 running on container engine 136. In certain embodiments, container management module 150 creates containers 130 based on one or more configuration files that define parameters (e.g., port mappings, storage, etc.) for the containers 130 that are to be deployed on container engine 136. The one or more configuration files are stored in cluster store (etcd) 147. Cluster store (etcd) 147 is a data store (e.g., database) used as a backing store for container management module 150, which may be a container orchestration platform implementing an orchestration control plane, such as a Kubernetes control plane. Herein, the terms container management module and container orchestration platform are used interchangeably, and thus both referenced by reference numeral 150. As shown, cluster store 147 is backed by storage resources of container virtual disk 1441. As discussed, there may be additional virtual disks backed by additional virtual disk files that store container data (e.g., are used by container volumes for storage, by cluster store 147, etc.).

From the perspective of each application 132 (and guest OS 138), file system calls are initiated by each containerized application 132 to implement file system-related data transfer and control operations (e.g., read and/or write I/Os), such as to virtual disk 1441. Calls are made to a particular virtual disk 1441 by referencing a container volume 146 associated with the particular virtual disk 1441. Such calls are translated by guest OS 138 into disk sector I/O requests that are passed through virtual HBA 142 to hypervisor 106. Hypervisor 106, then translates these requests into file access requests from container volumes 146 backed by second virtual disk file 128. In the case that storage 122 is a centralized storage system such as a storage area network (SAN) device or system, the data transfer and control operations may be passed through various layers of hypervisor 106 to true hardware HBAs 124 or network interface cards (NICs) 120 that connect to storage 122 as described in more detail below.

Storage 122 represents mass storage devices (e.g., one or more hard disks, flash memory modules, solid state drives (SSDs), and/or optical disks). Although the example embodiment shown in FIG. 1 illustrates storage 122 as local storage in hardware platform 108, in some embodiments, storage 122 is storage externally coupled to host 102.

Storage 122 may store multiple virtual disk files, such as first virtual disk file 126 and second virtual disk file 128. In certain aspects, virtual disk 1441 is a virtual storage for one or more containers 130 that has been manually provisioned, e.g., by an administrator, or dynamically or automatically provisioned, and virtual disk 1442 is a virtual storage for VM 104. In certain embodiments, each virtual disk 144 is backed by a file, such as a .vmdk or .vhd file or the like, containing a virtual disk image. In certain embodiments, virtual disk 1441 has a lifecycle independent of any individual container 130 that uses the virtual disk 1441. Accordingly, when all containers 130 associated with a virtual disk 1441 are removed from host 102 (e.g., all containers 130 are no longer running), virtual disk 1441 may still exist.

A storage layer 112 in hypervisor 106 is configured to receive and understand disk block-based I/O requests from guest OS 138, received via virtual HBA 142 running in VM 104. For example, storage layer 112 is configured to receive, from a container, disk block-based operations for writing data (e.g., for an application 132) to a container volume 146 of virtual disk 1441 and transfer such requests to storage layer 112.

Storage layer 112 in hypervisor 106 is configured to manage storage space for VMs 104. In one embodiment, storage layer 112 may include numerous logical layers, such as an I/O virtualization layer 182 and a disk access layer 184. In some embodiments, I/O virtualization layer 182 receives a disk block-based I/O from storage layer 112 (in the form of commands, for example, intended for a container volume 146) and converts the I/O into disk block-based I/O operations. I/O virtualization layer 182 then issues these disk block-based I/O operations to disk access layer 184 that applies command queuing and scheduling policies to the operations and ultimately sends the operations to components of physical hardware platform 108, and more specifically, storage 122 to read and/or write data to blocks stored in container volume 146 as second virtual disk file 128.

Hardware platform 108 of each host 102 includes components of a computing device such as one or more processors (central processing units (CPUs)) 118, memory 116 (e.g., storing counter(s) 188), a network interface card including one or more network adapters, also referred to as NICs 120, storage 122, HBA 124, and other I/O devices such as, for example, a mouse and keyboard (not shown). CPU 118 is configured to execute instructions, for example, executable instructions that perform one or more operations described herein and that may be stored in memory 116 and in storage 122. NIC 120 enables host 102 to communicate with other devices via a communication medium. HBA 124 couples host 102 to one or more external storages (not shown), such as a storage area network (SAN).

To allow for use of container volumes 146 by containers 130, container volumes 146 are first created and deployed in host 102. Creating one or more containers 130 and their associated storage (e.g., container volume(s) 146) may be based on information defined in a configuration file for the containers 130. The configuration file may be made up of one or more manifests that declare intended infrastructure (e.g., pods, containers, etc.) and applications 132 to be deployed on host 102. The manifests may be Javascript Object Notation (JSON) files, YAML files, etc., that indicate a number of containers 130, and a number of container volumes 146 per container 130, to create and deploy on host 102. Container management module 150 may use this information contained in the configuration file to create and deploy containers 130, as well as request deployment of their container volume(s) 146. As described above, container volumes 146 are created and assigned a share of disk I/O bandwidth allocated to a second virtual disk file 128 backing the container volume 146 in virtual disk 1441, and designated by a user.

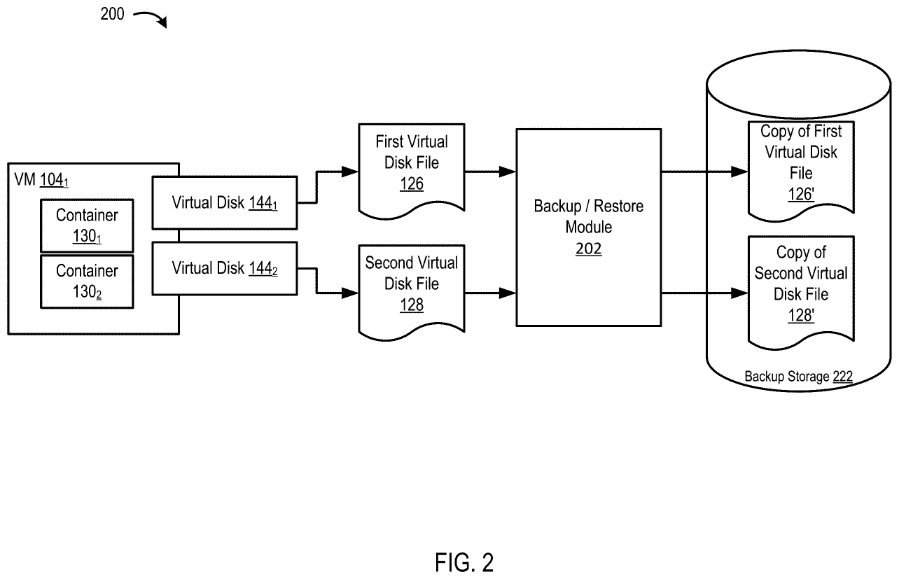

Turning to FIG. 2, a block representation of a backup system 200, in accordance with aspects of the present disclosure, is shown. As described above, with respect to FIG. 1, VM 104 may be configured to store VM data 145, such as runtime data and configuration data on virtual disk 1442 backed by first virtual disk file 126. The virtual disk file 126 may be structured in any appropriate virtual disk format, for example virtual disk image (VDI), virtual machine disk (VMDK), virtual hard disk (VHD) formats, or any other appropriate open source or proprietary file format. As discussed, there may be additional virtual disks backed by additional virtual disk files that store VM data 145.

Additionally, the VM 104, in aspects of the present disclosure, hosts one or more containers 130. These containers 130 are configured to store container data, e.g., application data, container configuration data, container runtime data, etc., in one or more container volumes 146 that use storage space of one or more virtual disks, such as virtual disk 1441. For example, the virtual disk 1441 may have a container partition, and the one or more container volumes may use storage space of the container partition. Accordingly, virtual disk 1441 stores container data, and does not store any VM data. Virtual disk 1441 may further provide storage for cluster store 147 providing configuration data used by the container management module 150 for implementing and maintaining the containers 130 hosted by the VM 104. Virtual disk 1441 is backed by second virtual disk file 128. As with first virtual disk file 126 described above, second virtual disk file 128 may be structured in any appropriate virtual disk format, such as VDI, VMDK, VHD formats, or any other appropriate open source or proprietary file format.

In certain aspects of the present disclosure, first virtual disk file 126 and second virtual disk file 128 are the same file format. In other aspects of the present disclosure, first virtual disk file 126 uses a first file format while second virtual disk file 128 uses a second file format that is different than the first file format.

Backup/restore module 202 (also referred to as backup module 202), can be used to backup the first virtual disk file 126 and the second virtual disk file 128 to backup first virtual disk file 126′ and backup second virtual disk file 128′, respectively. The backup first virtual disk file 126′ and backup second virtual disk file 128′ are stored in a backup storage 222, which may be the same as or separate from storage 122 of host 102. Backup storage 222, in certain aspects of the present disclosure, may be cloud storage. In other aspects of the present disclosure, storage 222 may be a network attached storage (NAS).

Since the virtual disks 144 are backed by first virtual disk file 126, including VM data 145, and second virtual disk file 128, including data of container volumes 146 and cluster store 147, the backup module 202 may be configured to backup each virtual disk file individually (separately), and in some cases, at different intervals. For example, the backup module 202 may be configured to backup first virtual disk file 126 prior to, and immediately following, a guest OS or VM update. Additionally, the backup module 202 may be configured to perform a backup of second virtual disk file 128 on a defined schedule, such as daily, hourly, or even more frequent intervals. In this way, the more frequently changing data backed by the second virtual disk file 128 can be backed up without incurring the unnecessary storage and processing overhead of also backing up the more static VM data 145, while still maintaining a robust disaster recovery strategy.

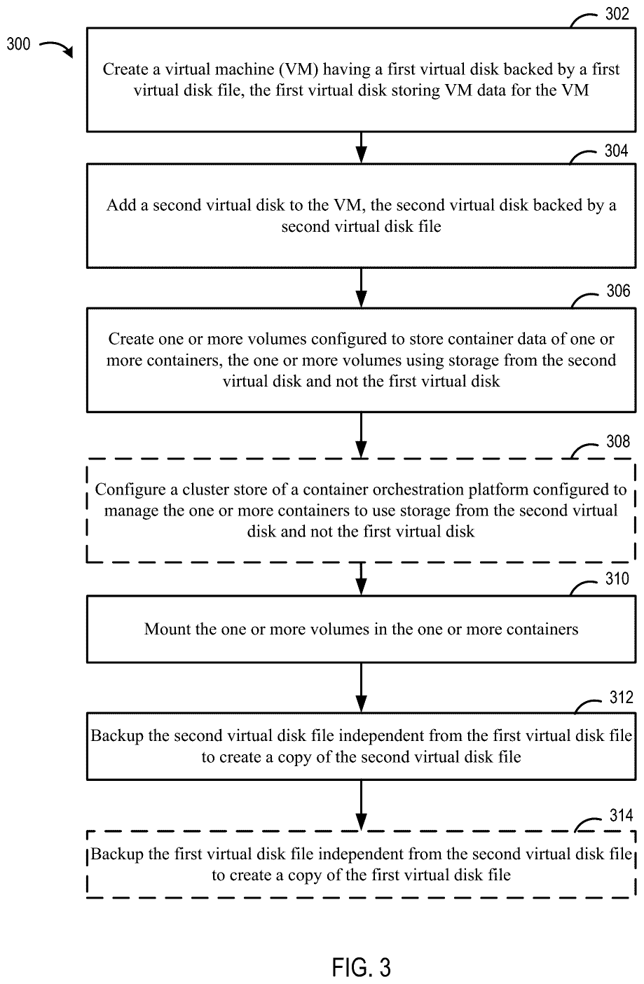

Turning to FIG. 3, a flow representation of a method 300 for managing container data for one or more containers 130 running in a VM 104 is shown.

At 302 of method 300, a process creates a VM 104 having a first virtual disk 1442 backed by a first virtual disk file 126. The first virtual disk 1442 stores VM data 145 for the VM 104. The VM may create one or more such first virtual disks backed by one or more first virtual disk files to store VM data 145. At 304 of method 300, a process adds a second virtual disk 1441 to the VM 104. The second virtual disk 1441 is backed by a second virtual disk file 128. The VM may create one or more such second virtual disks backed by one or more second virtual disk files. At 306 of method 300, a process creates one or more volumes 146 configured to store container data of the one or more containers 130. The one or more volumes 146 use storage from the second virtual disk 1441 (e.g., one or more second virtual disks) and not the first virtual disk 1442 (e.g., one or more first virtual disks).

Optionally, in certain aspects of the present disclosure, at 308 of method 300, a process configures a cluster store 147 of a container orchestration platform (e.g., container management module 150) configured to manage the one or more containers 130 to use storage from the second virtual disk 1441 (e.g., one or more second virtual disks) and not the first virtual disk 1442 (e.g., one or more first virtual disks).

At 310 of method 300, a process mounts one or more volumes 146 in the one or more containers 130. At 312 of method 300, the process backs up the second virtual disk file 128 (e.g., one or more second virtual disk files) independent from the first virtual disk file 126 (e.g., one or more first virtual disk files) to create a copy of the second virtual disk file 128′ (e.g., copies of the one or more second virtual disk files).

Optionally, in certain aspects of the present disclosure, at 314 of method 300, a process backs up the first virtual disk file 126 (e.g., one or more first virtual disk files) independent from the second virtual disk file 128 (e.g., one or more second virtual disk files) to create a copy of the first virtual disk file 126′ (e.g., copies of the one or more first virtual disk files).

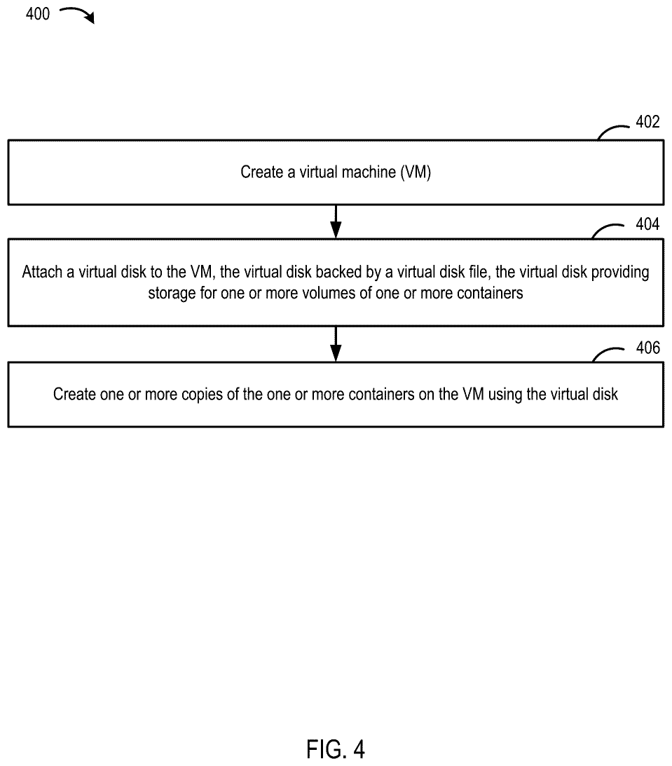

Turning to FIG. 4, a flow representation of a method 400 for restoring one or more containers 130 running in a VM 104 is shown.

At 402 of method 400, a process creates a virtual machine. At 404 of method 400, a process attaches a virtual disk 1441 (e.g., one or more virtual disks) to the VM 104. The virtual disk 1441 (e.g., one or more virtual disks) is used as storage for one or more volumes (e.g., container volumes 146) of one or more containers 130. At 406 of method 400, a process creates one or more copies of the one or more containers 130 on the VM 104 using the virtual disk 1441 (e.g., one or more virtual disks).

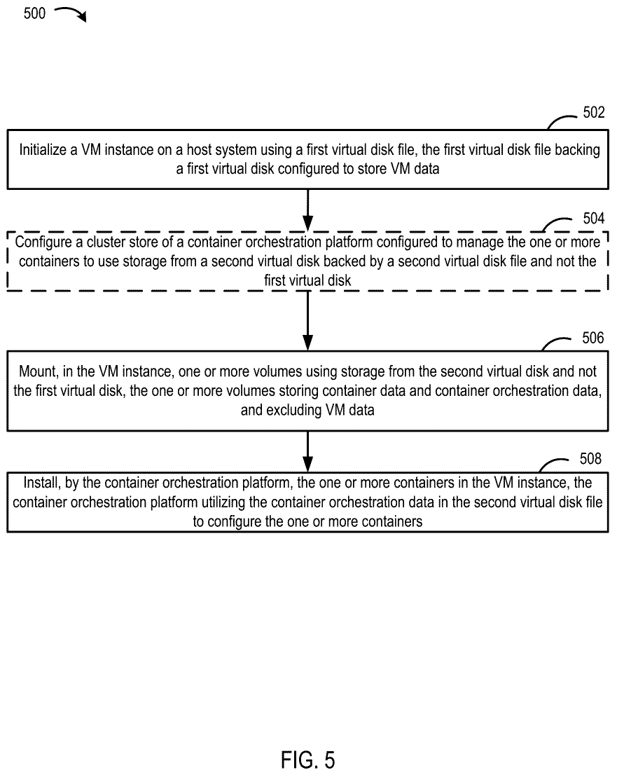

Turning to FIG. 5, a flow representation is shown of a method 500 for installing a VM 104 on a host system 102. The VM includes one or more containers 130 running thereon.

The method 500 begins at 502, where a process initializes a VM instance 104 on a host system 102 using a first virtual disk file 126. The first virtual disk file 126 backs a first virtual disk 1442 configured to store VM data 145.

Optionally, at 504 of the method 500, a process configures a cluster store 147 of a container orchestration platform (e.g., container management module 150) configured to manage the one or more containers 130 to use storage from the second virtual disk 1441 and not the first virtual disk 1442.

At 506 of the method, a process mounts, in the VM instance 104, one or more volumes (e.g., container volumes 146) using storage from a second virtual disk 1441 and not the first virtual disk 1442. The second virtual disk 1441 is backed by a second virtual disk file 128. The one or more volumes 146 storing container data and container orchestration data (e.g., etcd stored in cluster store 147), and excludes VM data 145. In certain aspects of the present disclosure, block 506 may be executed by container orchestration platform 150.

At 508 of the method, the container orchestration platform 150 installs the one or more containers 130 in the VM instance 104, the container orchestration platform 150 utilizing the container orchestration data in the second virtual disk file 128 to configure the one or more containers 130.

It should be understood that, for any workflow described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Disc), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

1. A method for managing container data for one or more containers running in a virtual machine (VM) having a first virtual disk backed by a first virtual disk file, the first virtual disk storing VM data for the VM, the method comprising:
adding a second virtual disk to the VM, the second virtual disk backed by a second virtual disk file;
creating one or more volumes configured to store container data of the one or more containers, the one or more volumes using storage from the second virtual disk and not the first virtual disk;
mounting the one or more volumes in the one or more containers; and
backing up the second virtual disk file independent from the first virtual disk file to create a copy of the second virtual disk file.

2. The method of claim 1, further comprising configuring a cluster store of a container orchestration platform configured to manage the one or more containers to use storage from the second virtual disk and not the first virtual disk.

3. The method of claim 1, further comprising:
creating a second VM;
attaching a copy of the second virtual disk to the second VM, the copy of the second virtual disk backed by the copy of the second virtual disk file; and
using the second virtual disk to create copies of the one or more containers on the second VM.

4. The method of claim 1, wherein the one or more volumes using storage from the second virtual disk and not the first virtual disk comprises the one or more volumes using a partition of the second virtual disk.

5. The method of claim 1, wherein the second virtual disk does not store any VM data.

6. The method of claim 1, wherein the VM data comprises one or more of: runtime data of the VM, guest operating system data of a guest operation system running on the VM, or configuration data of the VM.

7. The method of claim 1, wherein the container data comprises application data for one or more applications running on the one or more containers.

8. A system for managing container data for one or more containers running in a virtual machine (VM) having a first virtual disk backed by a first virtual disk file, the first virtual disk storing VM data for the VM, the system comprising:
memory; and
one or more processors configured to:
add a second virtual disk to the VM, the second virtual disk backed by a second virtual disk file;
create one or more volumes configured to store container data of the one or more containers, the one or more volumes using storage from the second virtual disk and not the first virtual disk;
mount the one or more volumes in the one or more containers; and
back up the second virtual disk file independent from the first virtual disk file to create a copy of the second virtual disk file.

9. The system of claim 8, wherein the one or more processors are further configured to:
configure a cluster store of a container orchestration platform configured to manage the one or more containers to use storage from the second virtual disk and not the first virtual disk.

10. The system of claim 7, wherein the one or more processors are further configured to:
create a second VM;
attach a copy of the second virtual disk to the second VM, the copy of the second virtual disk backed by the copy of the second virtual disk file; and
use the second virtual disk to create copies of the one or more containers on the second VM.

11. The system of claim 7, wherein the one or more volumes using storage from the second virtual disk and not the first virtual disk comprises the one or more volumes using a partition of the second virtual disk.

12. The system of claim 8, wherein the second virtual disk does not store any VM data.

13. The system of claim 8, wherein the VM data comprises one or more of: runtime data of the VM, guest operating system data of a guest operation system running on the VM, or configuration data of the VM.

14. The system of claim 8, wherein the container data comprises application data for one or more applications running on the one or more containers.

15. A non-transitory computer-readable medium comprising instructions, which when executed by one or more processors, cause the one or more processors to perform a method for managing container data for one or more containers running in a virtual machine (VM) having a first virtual disk backed by a first virtual disk file, the first virtual disk storing VM data for the VM, the method comprising:
adding a second virtual disk to the VM, the second virtual disk backed by a second virtual disk file;
creating one or more volumes configured to store container data of the one or more containers, the one or more volumes using storage from the second virtual disk and not the first virtual disk;
mounting the one or more volumes in the one or more containers; and
backing up the second virtual disk file independent from the first virtual disk file to create a copy of the second virtual disk file.

16. The non-transitory computer-readable medium of claim 15, wherein the method further comprises configuring a cluster store of a container orchestration platform configured to manage the one or more containers to use storage from the second virtual disk and not the first virtual disk.

17. The non-transitory computer-readable medium of claim 15, wherein the method further comprises:
creating a second VM;
attaching a copy of the second virtual disk to the second VM, the copy of the second virtual disk backed by the copy of the second virtual disk file; and
using the second virtual disk to create copies of the one or more containers on the second VM.

18. The non-transitory computer-readable medium of claim 15, wherein the one or more volumes using storage from the second virtual disk and not the first virtual disk comprises the one or more volumes using a partition of the second virtual disk.

19. The non-transitory computer-readable medium of claim 15, wherein the second virtual disk does not store any VM data.

20. The non-transitory computer-readable medium of claim 15, wherein the VM data comprises one or more of: runtime data of the VM, guest operating system data of a guest operation system running on the VM, or configuration data of the VM.
